(19) United States
(12) Patent Application Publication
(10) Pub. No.: US 2025/0378125 A1
(43) Pub. Date: Dec. 11, 2025

(54) TECHNIQUES FOR SUPPLEMENTING FOR WEB CONTENT

(71) Applicant: Apple Inc., Cupertino, CA (US)

(72) Inventors: Yongjun ZHANG, Sunnyvale, CA (US); Amit JAIN, Santa Clara, CA (US); Charles H. YING, San Mateo, CA (US); Priyanka JAIN, Boston, MA (US); Shreya R. VYAS, Palo Alto, CA (US); Steven J. FALKENBURG, Los Altos, CA (US); Zuha AGHA, San Jose, CA (US)

(21) Appl. No.: 19/088,310

(22) Filed: Mar. 24, 2025

Related U.S. Application Data
(60) Provisional application No. 63/657,846, filed on Jun. 8, 2024.

(51) Int. Cl. G06F 16/958; G06F 16/955; G06F 16/957

(52) U.S. Cl. CPC G06F 16/958; G06F 16/955; G06F 16/9574

(57) ABSTRACT

The embodiments set forth techniques for managing webpage supplements for webpages.

### CROSS-REFERENCE TO RELATED APPLICATIONS

The present application claims priority to U.S. Provisional Patent Application Ser. No. 63/657,846, entitled “TECHNIQUES FOR SUPPLEMENTING FOR WEB CONTENT” filed Jun. 8, 2024, which is hereby incorporated by reference in its entirety for all purposes.

### FIELD

The described embodiments relate generally to managing operational aspects of web browsers. More particularly, the described embodiments provide techniques for enabling web browsers to benefit from machine learning (ML) models—such as large language models (LLMs)—by managing webpage supplements for webpages in a manner that addresses latency and privacy considerations.

### BACKGROUND

Web browsers, and/or web browser extensions, can access large language models (LLMs) to provide useful features, including the ability to summarize the content of webpages that are accessed through the web browsers. This feature can save users considerable time and effort, in that it allows them to quickly grasp the main points of lengthy articles, research papers, news reports, etc., without needing to read through the entire content. Such functionality is particularly valuable in academic research, professional settings, and even casual web browsing, where users are often tasked with sifting through multiple sources to extract relevant information.

Unfortunately, current implementations for providing the aforementioned features are rife with latency issues. In particular, LLMs—especially those based on advanced architectures—are computationally intensive and require substantial processing power to operate. These issues are exacerbated when large inputs—such webpages that are lengthy in content—are provided to LLMs. This can lead to delays in delivering desired content to web browsers/extensions, especially if the entities implementing the LLMs are inundated with tasks, if network bandwidth is congested, and so on. These issues can result in latencies that detract from the user experience, thereby making the summarization feature unreliable, inconvenient, and/or cumbersome to utilize.

Accordingly, what is needed are techniques for enabling web browsers to provide LLM—related features in a manner that mitigates the aforementioned latency issues.

### SUMMARY

The described embodiments relate generally to managing operational aspects of web browsers. More particularly, the described embodiments provide techniques for enabling web browsers to benefit from machine learning (ML) models—such as large language models (LLMs)—by managing webpage supplements for webpages in a manner that addresses latency and privacy considerations.

The embodiments set forth techniques for managing webpage supplements for webpages. According to some embodiments, the method can be implemented by a client computing device, and includes the steps of (1) receiving a first request to load a webpage associated with a uniform resource locator (URL), (2) identifying, by comparing a domain of the URL against a probabilistic data structure, that there potentially exists a respective at least one webpage supplement for the webpage, where: (i) the probabilistic data structure is based on a plurality of domains, and (ii) respective one or more webpage supplements exist for each domain of the plurality of domains, (3) identifying, by interfacing with a management entity, that the respective at least one webpage supplement in fact exists, (4) displaying at least one affordance that corresponds to the respective at least one webpage supplement, (5) receiving, by way of the at least one affordance, a second request to access the respective at least one webpage supplement, and (6) causing at least a portion of the respective at least one webpage supplement to be output by way of a user interface

Other embodiments include a non-transitory computer readable storage medium configured to store instructions that, when executed by a processor included in a computing device, cause the computing device to carry out the various steps of any of the foregoing methods. Further embodiments include a computing device that is configured to carry out the various steps of any of the foregoing methods.

Other aspects and advantages of the invention will become apparent from the following detailed description taken in conjunction with the accompanying drawings that illustrate, by way of example, the principles of the described embodiments.

### BRIEF DESCRIPTION OF THE DRAWINGS

The disclosure will be readily understood by the following detailed description in conjunction with the accompanying drawings, wherein like reference numerals designate like structural elements.

FIG. 1A illustrates a system diagram of a computing device that can be configured to perform the various techniques described herein, according to some embodiments.

FIG. 1B illustrates conceptual diagrams of example information that can be provided to client computing devices, according to some embodiments.

FIGS. 2A-2C illustrate a method for managing webpage supplements for webpages, according to some embodiments.

FIGS. 3A-3D illustrate conceptual diagrams of additional example user interfaces that can be provided by a web browser application in conjunction with carrying out the techniques described herein, according to some embodiments.

FIGS. 4A-4B illustrate conceptual diagrams of additional example user interfaces that can be provided by a web browser application in conjunction with carrying out the techniques described herein, according to some embodiments.

FIG. 5 illustrates a detailed view of a computing device that can be used to implement the various techniques described herein, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description, and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly, a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

The described embodiments relate generally to managing operational aspects of web browsers. More particularly, the described embodiments provide techniques for enabling web browsers to benefit from machine learning (ML) models—such as large language models (LLMs)—by managing webpage supplements for webpages in a manner that addresses latency and privacy considerations.

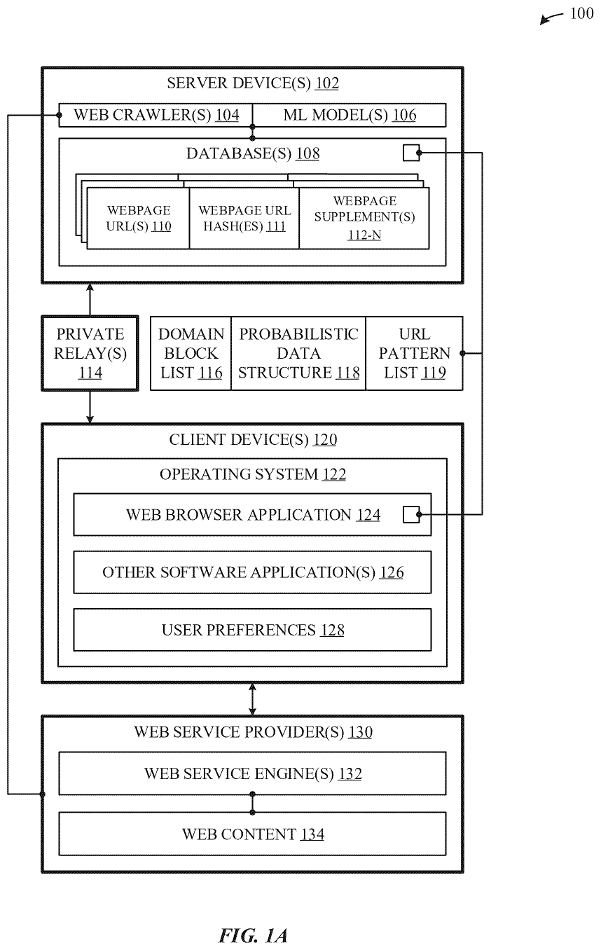

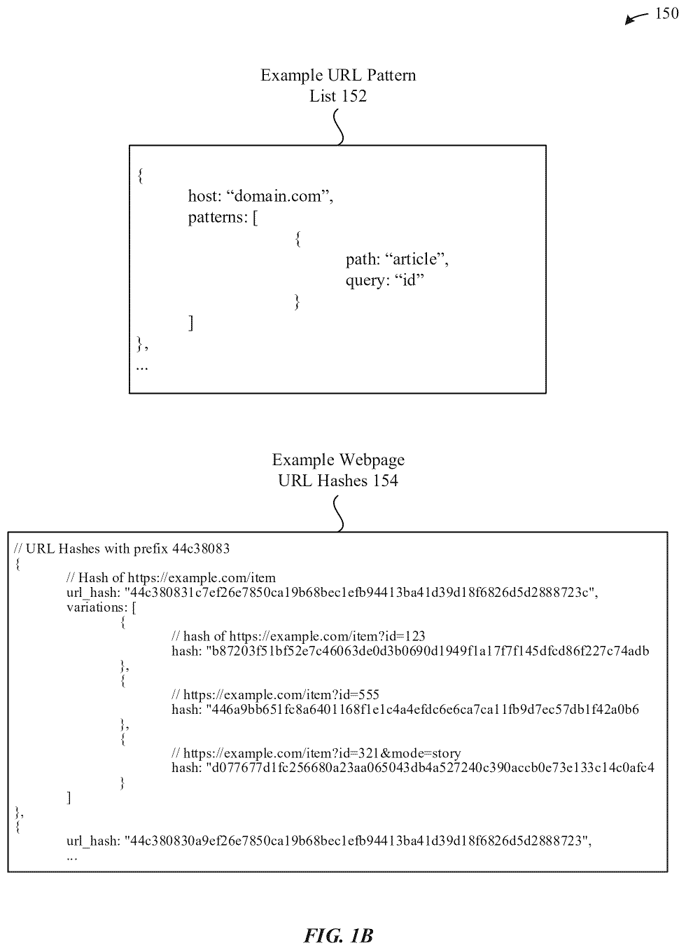

A more detailed discussion of these techniques is set forth below and described in conjunction with FIGS. 1-5, which illustrate detailed diagrams of systems and methods that can be used to implement these techniques.

FIG. 1A illustrates a block diagram of different components of a system 100 that can be configured to implement the various techniques described herein, according to some embodiments. As shown in FIG. 1A, the system 100 can include server computing devices 102, private relays 114, client computing devices 120, and web service providers 130. It is noted that the aforementioned devices—as well as the different entities implemented by those devices—are discussed in singular capacities in the interest of simplifying this disclosure. In that regard, it should be appreciated that the system 100 can include any number of server computing devices 102, private relays 114, client computing devices 120, and web service providers 130, consistent with the scope of this disclosure.

According to some embodiments, and as shown in FIG. 1A, a given client computing device 120 can implement (i.e., store, load, execute, etc.) an operating system 122 capable of executing a web browser application 124, as well as other software applications 126 (e.g., software applications native to the operating system 122, third-party software applications installed onto the operating system 122 (e.g., via a Software Application Store (i.e., “App Store”), via over the air provisioning, etc.), and so on). The operating system 122 can also manage user preferences 128. For example, the user preferences 128 can be established and managed by one or more of the operating system 122, the web browser application 124, the other software application(s) 126, and so on. The user preferences 128 can optionally be provided to one or more server computing devices 102 (e.g., during a cloud backup procedure). For example, the server computing device 102 can provide cloud-based backups of the user preferences 128, distributions of the user preferences 128 to associated/respective client computing devices 120, and so on. As described herein, the user preferences 128 can guide the manner in which webpage supplements 112 are selected for, recommended to, provided to, etc., the client computing device 120 (when appropriate).

As a brief aside, it is noted that the embodiments described herein primarily involve web browser applications (i.e., the web browser application 124) in the interest of simplifying this disclosure. However, the same (or similar) techniques can be implemented in any software application without departing from the scope of this disclosure. For example, a web services application—such as a streaming client configured to stream media content from server computing devices—can implement the same (or similar) features of the web browser application 124 described herein. In other examples, the same (or similar techniques) can be implemented by operating systems, productivity applications, multimedia applications, gaming applications, utility applications, communications applications, education applications, finance applications, health applications, and so on. It is further noted that the terms “website” and “webpage” can represent a single webpage, or multiple webpages, associated with a particular domain, URL, and so on.

According to some embodiments, and as shown in FIG. 1A, a given web service provider 130 can include one or more web service engines 132 configured to provide web content 134. For example, a given web service engine 132 can host a website derived from the web content 134. In another example, a given web service engine 132 can host a service that streams content that is stored within the web content 134. It is noted that the foregoing examples are not meant to be limiting, and that the web service providers 130 can provide any form of network-based functionality without departing from the scope of this disclosure.

As shown in FIG. 1A, a given server computing device 102 can implement one or more web crawlers 104 that systematically browse the Internet to index and collect data from websites. For example, the web crawler 104 can start with a list of uniform resource locators (URLs), visit the websites, and follow hyperlinks on each page to discover new URLs, continuing this process iteratively. As the web crawler 104 navigates through webpages, the web crawler 104 can gather information such as text content, media content, metadata, links, etc.—which, as described below in greater detail, can be used for generating webpage supplements 112.

As also shown in FIG. 1A, the server computing device 102 can implement one or more machine learning models 106. According to some embodiments, the machine learning models 106 can represent small language models (SLMs), large language models (LLMs), rule-based models, ranking models, traditional machine learning models, custom models, ensemble models, knowledge graph models, hybrid models, domain-specific models, sparse models, transfer learning models, symbolic artificial intelligence (AI) models, generative adversarial network models, reinforcement learning models, biological models, and so on. The machine learning models 106 can also represent image generation models, video generation models, music generation models, text-to-speech models, speech-to-text models, game generation models, 3d model generation models, virtual character generation models, content recommendation models, and so on. It is noted that the foregoing examples are not meant to be limiting, and that any number, type, form, etc., of AI/ML model(s), can be implemented by any of the entities illustrated in FIG. 1A, consistent with the scope of this disclosure.

According to some embodiments, the server computing device 102 can utilize the web crawler 104, the machine learning model 106, etc., to identify webpages for which respective one or more webpage supplements 112 can be generated. For example, a given webpage supplement 112 for a webpage can include a summary of content included in the webpage, a table of contents of different sections included in the webpage, identifications of people, places, topics, media content, etc., included in the webpage, and the like. It is noted that the foregoing examples are not meant to be limiting, and that any number of webpage supplements 112 can be generated for a given webpage, and that each webpage supplement 112 can include any amount, type, form, etc., of information, at any level of granularity, consistent with the scope of this disclosure.

According to some embodiments, when the server computing device 102 generates one or more webpage supplements 112 for a given webpage associated with a uniform resource locator (URL), the server computing device 102 can store the webpage supplements 112 in a database 108, and can associate the webpage supplements 112 with the webpage by way of one or more URLs known to be associated with the webpage (illustrated in FIG. 1A as webpage URLs 110). In this manner—and, as described in greater detail herein—the server computing device 102 can efficiently look up the URL(s) of a given webpage to determine whether at least one webpage supplement 112 has been generated/exists for the webpage.

According to some embodiments, and as described in greater detail herein, the server computing device 102/client computing device 120 can employ hash functions to enhance privacy and security measures. In particular, the server computing device 102 can generate/store, for each database 108 entry for a given webpage, respective webpage URL hash values 111 derived from the webpage URLs 110 associated with the webpage. Different/appropriate hash functions can be utilized to generate a webpage URL hash value 111 from a given webpage URL 110, e.g., a Message Digest Algorithm, a Secure Hash Algorithm, and so on. It is noted that the foregoing examples are not meant to be limiting, and that any number, type, form, etc., of hash function(s) can be utilized to generate a webpage URL hash value 111 from a webpage URL 110, consistent with the scope of this disclosure.

Additionally, it should be appreciated that different operations can be performed on a given webpage URL 110 prior to generating the webpage URL hash value 111, that different operations can be performed on the webpage URL hash value 111 after the webpage URL hash value 111 is generated, and so on. For example, the webpage URL 110 can be filtered, modified, etc., prior to generating a webpage URL hash value 111 based on the webpage URL 110, and/or the webpage URL hash value 111 can be filtered, modified, etc., subsequent to generating the webpage URL hash value 111. It is noted that the foregoing examples are not meant to be limiting, and that the webpage URL 110/webpage URL hash value 111 can be modified using any number, type, form, etc., of operation(s), at any level of granularity, consistent with the scope of this disclosure. It is additionally noted that the modifications to the webpage URLs 110, webpage URL hash values 111, etc., can be stored in the database 108, where appropriate, to improve operational efficiencies so that they do not need to be recalculated to perform different lookup operations.

According to some embodiments, and as shown in FIG. 1A, the server computing device 102 can generate, manage, etc., a domain block list 116 that stores a collection of domains for which the server computing device 102 does not generate, store, etc., webpage supplements 112. According to some embodiments, the server computing device 102 can provide the domain block list 116 to client computing devices 120 to enable the client computing devices 120—specifically, web browser applications 124 executing thereon—to readily determine that webpage supplements 112 in fact are not available for a given webpage (and thereby determine that no further action should be taken on the matter).

According to some embodiments, and as shown in FIG. 1A, the server computing device 102 can generate, manage, etc., a probabilistic data structure 118 that is based on a collection of domains for which the server computing device 102 has generated, stored, etc., webpage supplements 112. The server computing device 102 can provide the probabilistic data structure 118 to client computing devices 120 to enable the client computing devices 120—specifically, the web browser applications 124 executing thereon—to determine that webpage supplements 112 (1) in fact are not available for a given webpage (and take no further action on the matter), or (2) may potentially be available for the webpage (due to the probabilistic nature of the probabilistic data structure 118), where further action can be taken. The probabilistic data structure 118 can represent, for example, a Bloom Filter, a Count-Min Sketch, a HyperLogLog, a Skip Bloom Filter, a Quotient Filter, a Cuckoo Filter, a Randomized Binary Search Tree, a MinHash, a Random Hyperplane Tree, etc. It is noted that the foregoing examples are not meant to be limiting, and that the probabilistic data structure 118 can represent any number, type, form, etc., of probabilistic data structure(s), at any level of granularity, consistent with the scope of this disclosure.

According to some embodiments, and as shown in FIG. 1A, the server computing device 102 can generate, manage, etc., a URL pattern list 119 that is based on the webpage URLs 110 and webpage URL hash values 111 stored in the database 108. According to some embodiments, the URL pattern list 119 can include information that describes, for each unique domain, a respective abstraction of the structure(s) of different paths, queries, fragments, etc., typically found in URLs to webpages associated with the domain. An example of a URL pattern list 119 is illustrated in the conceptual diagram 150 of FIG. 1B as the example URL pattern list 152. As shown in FIG. 1B, the example URL pattern list 119 includes an entry for the domain “domain.com”, and indicates that URLs associated with that domain typically include the path “articles” and the query “id”. In this regard, the URL pattern list 119 can be utilized to identify extraneous/irrelevant information that may be included in URLs associated with the domain, e.g., “&tracking=abc” in the URL “www.domain.com/articles/id=123&tracking=abc”. As described in greater detail herein, disregarding such information can improve the overall efficiency by which the techniques described herein are implemented. It is noted that the example URL pattern list 119 illustrated in FIG. 1B is not meant to be limiting, and that the URL pattern list 119 can be organized in any manner, and can include any amount, type, form, etc., of information, at any level of granularity, consistent with the scope of this disclosure.

According to some embodiments, the server computing device 102 can register a given domain with the URL pattern list 119 when particular conditions are satisfied. For example, the server computing device 102 can register the domain when a threshold percentage of URLs associated with the domain (that are known to the server computing device 102) do not include query string arguments. In another example, the server computing device 102 can register the domain when a threshold number of URLs associated with the domain constitute URL variations. It is noted that the foregoing examples are not meant to be limiting, and that the server computing device 102 can register a given domain with the URL pattern list 119 based on any amount, type, form, etc., of information, at any level of granularity, consistent with the scope of this disclosure.

According to some embodiments, the server computing device 102 can be configured to provide the URL pattern list 119 to client computing devices 120. In this regard, a given client computing device 120—specifically, a web browser application 124 executing thereon—can utilize the URL pattern list 119 to simplify, conform, etc., a given URL (of a webpage being accessed by the web browser application 124) based on the URL pattern list 119 (when applicable, i.e., when the URL is associated with a domain that is referenced in the URL pattern list 119). As described in greater detail herein, the simplified/conformed URL can improve efficiency, security, privacy, etc., when the web browser application 124 interfaces with the server computing device 102 to determine whether any webpage supplements 112 are available for the webpage.

According to some embodiments, and as described in greater detail herein, when a web browser application 124 executing on a client computing device 120 visits a given webpage associated with a URL, the web browser application 124 can first reference the domain block list 116 to determine whether a domain of the URL is included in the domain block list 116. If the URL is included in the domain block list 116, then the web browser application 124 can effectively determine that no further action should be taken (as no webpage supplements 112 are available for the webpage). However, if the URL is not in the domain block list 116, then the web browser application 124 can reference the probabilistic data structure 118 to determine whether the URL is in fact not referenced by probabilistic data structure 118 (where no further action should be taken), or may (due to the probabilistic nature of the probabilistic data structure 118) be referenced by the probabilistic data structure 118. If the URL is in fact not referenced by the probabilistic data structure 118, then the web browser application 124 effectively determines that the server computing device 102 has not generated any webpage supplements 112 (at least up to the time that the probabilistic data structure 118 was generated based on the database 108). Conversely, if the URL is referenced by the probabilistic data structure 118, then the web browser application 124 effectively determines that the server computing device 102 may (due to the probabilistic nature of the probabilistic data structure 118) have generated a webpage supplement 112 that can be provided for the webpage.

According to some embodiments, when the web browser application 124 determines that at least one webpage supplement 112 may exist for the webpage, the web browser application 124 can interface with the server computing device(s) 102 (e.g., via at least one secure communications channel), and issue a request for a definitive answer about whether at least one webpage supplement 112 has in fact been generated for the webpage. The request can include, for example, the URL of the webpage, identifying information associated with the client computing device 120, identifying information associated with a user account associated with the client computing device 120, user preferences 128 associated with the client computing device 120, and so on. It is noted that the foregoing examples are not meant to be limiting, and that the request can include any amount, type, form, etc., of information, at any level of granularity, consistent with the scope of this disclosure.

According to some embodiments, when the server computing device 102 receives the request, the server computing device 102 can identify whether the URL included in the request matches any of the webpage URLs 110 stored in the database 108. If a match is found, then the server computing device 102 can provide an indication of the webpage supplements 112 that are associated with/available for the webpage. The web browser application 124 can then provide, by way of a user interface, an indication that the webpage supplements 112 are available, an ability to select the webpage supplements 112, and so on. When a selection of a given webpage supplement 112 is made, the web browser application 124 can issue (to the server computing device 102) a request for the webpage supplement 112. The server computing device 102 can then obtain and provide the webpage supplement 112 to the web browser application 124. In turn, the web browser application 124 can enable the webpage supplement 112 to be accessed on the client computing device 120. It is noted that different techniques can be employed to improve efficiency, privacy, etc., aspects associated with the client computing device 120 and the server computing device 102 exchanging information about webpages, URLs, webpage supplements 112, etc., being accessed by the client computing device 120, which are described in greater detail herein.

As a brief aside—and, as shown in FIG. 1A—the client computing device 120 and the server computing device 102 can be configured to communicate by way of private relays 114 in order to provide security, privacy, etc., benefits. In one example, the client computing device 120 can communicate with the server computing device 102 using iCloud Private Relay. In another example, the client computing device 120 communicates with the server computing device 102 using Oblivious HTTP. In another example, the client computing device 120 communicates with the server computing device 102 using one or more proxies that ensure privacy by anonymizing Internet Protocol (IP) addresses of client computing device 120. In another example, the client computing device 120 communicates with the server computing device 102 using a virtual private network. In another example, the client computing device 120 communicates with the server computing device 102 using a private information retrieval (PIR) protocol. In another example, the client computing device 120 communicates with the server computing device 102 using any suitable communication method that promotes security and/or privacy. It is noted that the foregoing examples are not meant to be limiting, and that client computing device 120 and the server computing device 102 can communicate with one another using any approach, consistent with the scope of this disclosure.

As a brief aside, it is noted that iCloud Private Relay provides a highly secure framework for enabling a first device (e.g., a client computing device 120) to communicate with a second device (e.g., a server computing device 102) while significantly constraining the ability for intermediate parties (e.g., an Internet Service Provider) to glean information about the first device, the second device, and/or data transmitted therebetween. When iCloud Private Relay is utilized by the first device, requests sent by the first device to the second device are sent through two separate and distinct Internet relays. Under this approach, the Internet Protocol (IP) address of the first device is visible to a first Internet relay (e.g., one operated by Apple, Inc.) and to the Internet Service Provider utilized by the client computing device 120. However, Domain Name Service (DNS) records associated with the requests are encrypted, so neither the first Internet relay—nor the ISP—can identify information about the second device (e.g., a name, an IP address, etc.) included in the requests. To achieve this limitation, the second Internet relay—which can be operated by a third-party provider—generates a temporary IP address, decrypts the information about the second device, and then effectively establishes one or more secure communication channels between the first and second device by way of the ISP, the first Internet Relay, and the second Internet relay. Additionally, the secure communication channels can implement the latest Internet standards to enable highly efficient and protected communications to be carried out between the first and second devices.

According to some embodiments, the aforementioned techniques can involve the client computing device 120 utilizing a private relay protocol to establish a secure communication channel between the client computing device 120 and the server computing device 102, where (1) the private relay protocol utilizes at least first and second Internet relays that are logically disposed between the client computing device 120 and the server computing device 102, (2) a first address of the client computing device 120 is accessible to the first Internet relay but not to the second Internet relay, and (3) a second address of server computing device 102 is accessible to the second Internet relay but not to the first Internet relay. Under this configuration, the client computing device 120 and the first Internet relay transmit information between one another, the first Internet relay and the second Internet relay transmit information between one another, and the second Internet relay and the server computing device 102 communicate information between one another.

It should be understood that the various components of the computing devices illustrated in FIG. 1A are presented at a high level in the interest of simplification. For example, although not illustrated in FIG. 1A, it should be appreciated that the various computing devices can include common hardware/software components that enable the above-described software entities to be implemented. For example, each of the computing devices can include one or more processors that, in conjunction with one or more volatile memories (e.g., a dynamic random-access memory (DRAM)) and one or more storage devices (e.g., hard drives, solid-state drives (SSDs), etc.), enable the various software entities described herein to be executed. Moreover, each of the computing devices can include communications components that enable the computing devices to transmit information between one another.

A more detailed explanation of these hardware components is provided below in conjunction with FIG. 6. It should additionally be understood that the computing devices can include additional entities that enable the implementation of the various techniques described herein without departing from the scope of this disclosure. It should additionally be understood that the entities described herein can be combined or split into additional entities without departing from the scope of this disclosure. It should further be understood that the various entities described herein can be implemented using software-based or hardware-based approaches without departing from the scope of this disclosure.

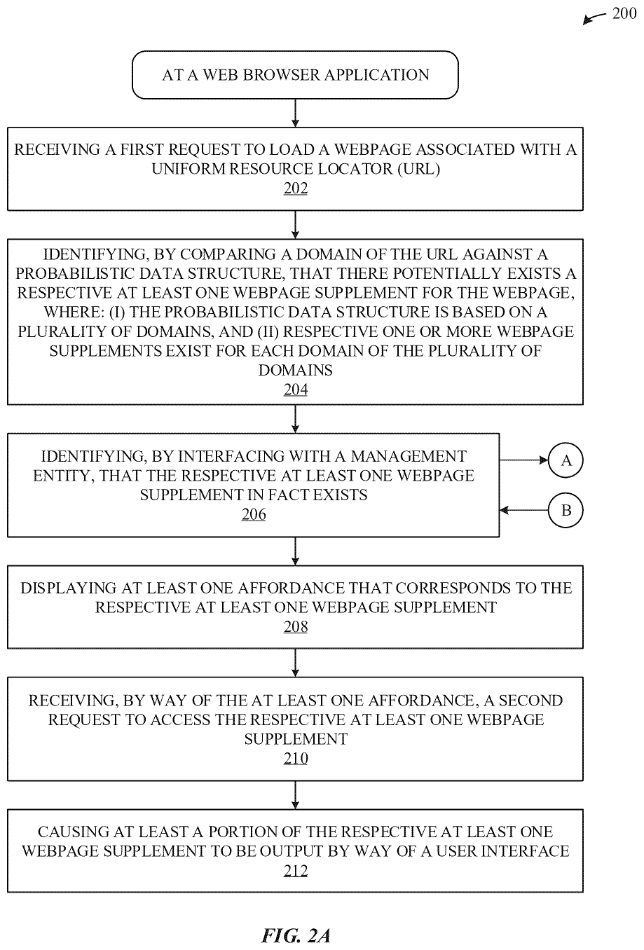

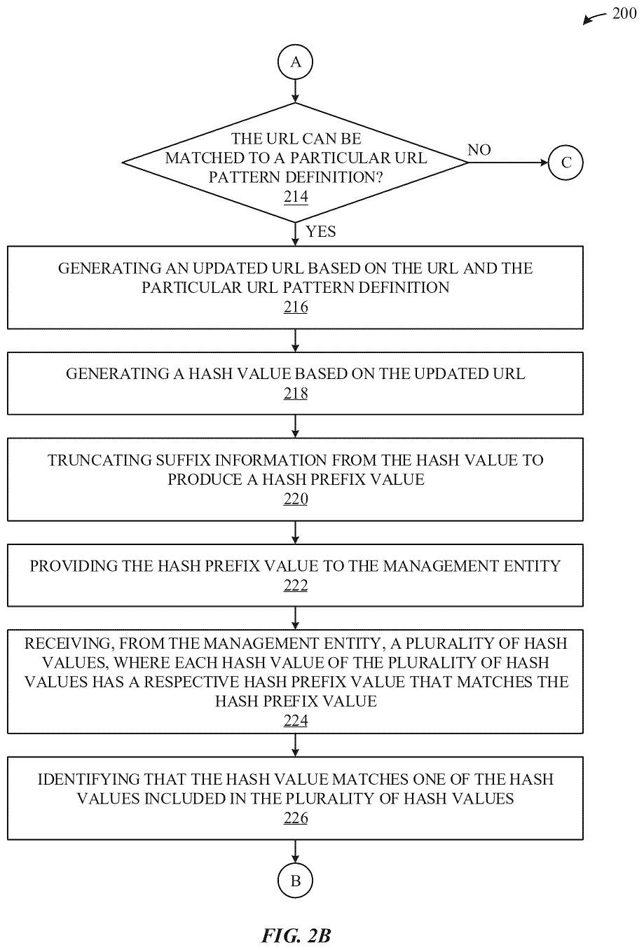

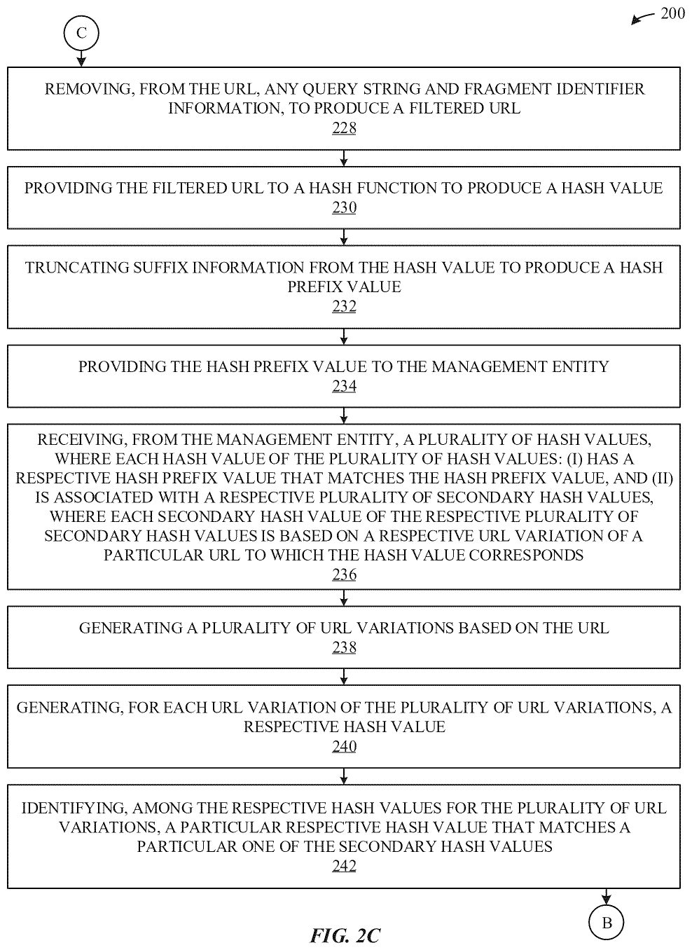

Accordingly, FIG. 1A provides an overview of the manner in which the system 100 can implement the various techniques described herein, according to some embodiments. A more detailed breakdown of the manner in which these techniques can be implemented will now be provided below in conjunction with FIGS. 2A-2C, 3A-3D, and 4A-4B.

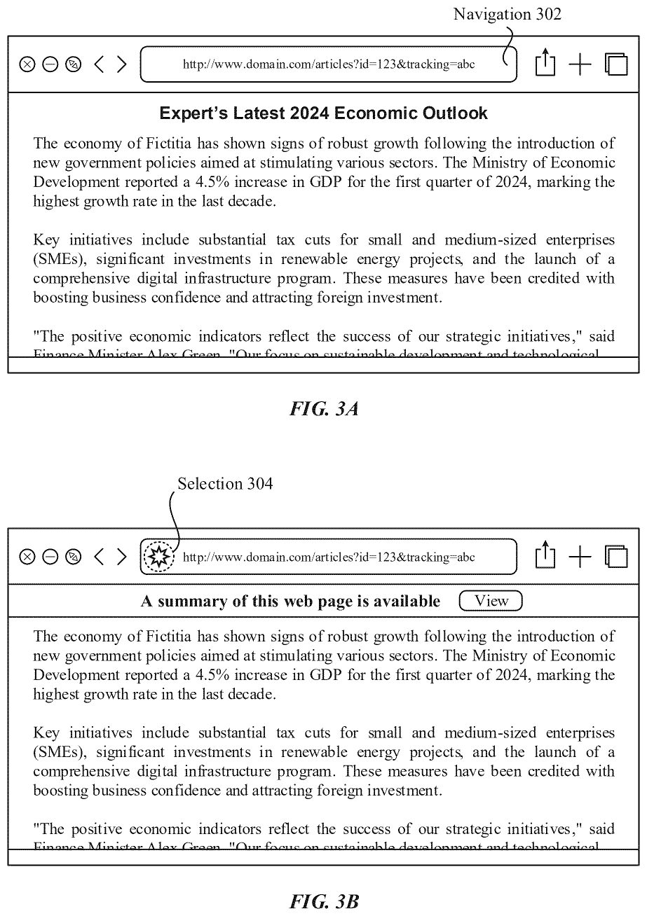

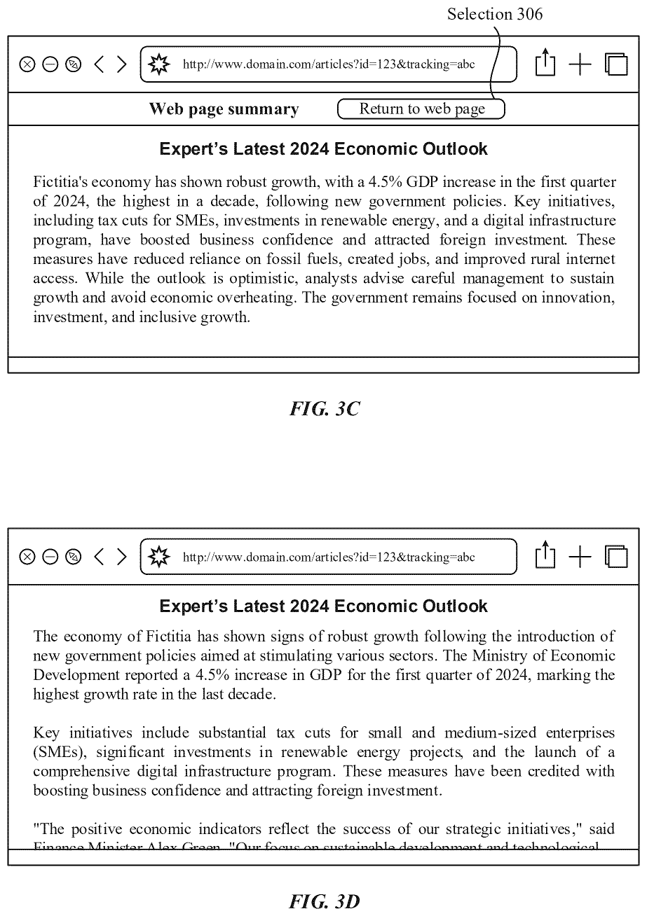

FIGS. 2A-2C illustrate a method 200 for managing webpage supplements 112 for webpages, according to some embodiments. As shown in FIG. 2A, the method 200 begins at step 202, where a web browser application 124 executing on a client computing device 120 receives a first request to load a webpage associated with a uniform resource locator (URL). An example scenario of step 202 is provided in FIG. 3A, which shows an example user interface of the web browser application 124. As shown in FIG. 3A, the web browser application 124 has navigated (by way of a navigation 302 performed by a user, automatically, etc.) to the webpage at the URL “http://www.domain.com/articles?id=123”, which constitutes a news article about an economic outlook for the economy of Fictitia.

At step 204, the web browser application 124 identifies, by comparing a domain of the URL—i.e., “domain.com”—against the probabilistic data structure 118, that there potentially exists a respective at least one webpage supplement 112 for the webpage. Although not illustrated in FIG. 2A, it should be appreciated that the web browser application 124 can, prior to comparing the domain against the probabilistic data structure 118, verify that the domain is not included in the domain block list 116. As described herein, the probabilistic data structure 118 (e.g., a Bloom filter) is based on a plurality of domains for which a server computing device 102 has generated at least one webpage supplement 112. In this regard, the web browser application 124 can (1) readily determine that no webpage supplements 112 exist for the webpage, or (2) that at least one webpage supplement 112 potentially exists for the webpage. As noted above, and illustrated in FIG. 2A, step 204 constitutes a scenario where at least one webpage supplement 112 potentially exists for the webpage. In that regard, the web browser application 124 takes additional steps to determine whether the at least one webpage supplement 112 in fact exists for the webpage.

Accordingly, at step 206, the web browser application 124 identifies, by interfacing with a management entity (i.e., the server computing device 102), that the respective at least one webpage supplement 112 in fact exists. Notably, it can be beneficial, at least with regard to privacy considerations, to enable the web browser application 124 to determine whether the server computing device 102 is in possession of at least one webpage supplement 112 for the webpage, without directly exposing information about the webpage to the server computing device 102. To achieve this privacy benefit, the web browser application 124 can be configured to utilize different approaches that substantially reduce the amount of information the server computing device 102 is able to glean about web browsing activity taking place through the web browser application 124. These approaches are described below in conjunction with FIGS. 2B-2C.

According to some embodiments, the web browser application 124 can be configured to generate a hash value based on the URL (or, as described below, based on a simplified/conformed version of the URL) using the same hash function that the server computing device 102 utilizes to generate the webpage URL hash values 111. The web browser application 124 can also be configured to truncate the hash value such that the truncated hash value constitutes a prefix of the hash value (referred to herein as “hash prefix value”). The amount of information truncated from the hash value can be based on a desired length, size, etc., for the hash prefix value. In any case, when the web browser application 124 provides the hash prefix value to the server computing device 102, the server computing device 102 is only able to look up one or more webpage URL hash values 111 having prefixes that match the hash prefix value. Consequently, the server computing device 102 is limited in its ability to gather, deduce, etc., broad web browsing information through passive requests about whether webpage supplements 112 exist for webpages (which, as described herein, can be transmitted by web browser applications 124 as web browsing activity is carried out).

In some cases, the URL is associated with a website that organizes its URLs such that extraneous information is often included in the URLs, at least with respect to uniquely identifying a webpage to which the URL corresponds. In this regard, the URL, by way of the extraneous information, if any, incorporated therein, may constitute one of a considerable number of variations of the URL. Consider the example website “domain.com”, which organizes its news articles using “/articles?id=”, where a unique identifier is incorporated into the URL to refer to a particular news article. Under this organization, if one thousand news articles are managed by the website, then the URLs “www.domain.com/articles?id=1”, “www.domain.com/articles?id=2”, . . . , “www.domain.com/articles?id=1000” may be associated with the website. Moreover, one or more of the aforementioned URLs may be associated with variation URLs that include extraneous information. For example, the URL “domain.com/articles?id=1” may also be associated with the URL variations “domain.com/articles?id=1&tracking=abc”, “domain.com/articles?id=1&tracking=def”, and “domain.com/articles?id=1&tracking=ghi”, where each of the URLs corresponds to the same webpage. Accordingly, it would be inefficient/imprudent for the server computing device 102 to manage, track, etc., the URL variations, given the inefficiencies that would stem from such a practice. Instead, the server computing device 102 can manage, track, etc., URLs that conform to the URL pattern list 119, which can involve storing the URLs in the database 108, generating webpage URL hash values 111, and so on.

Accordingly, the web browser application 124 can utilize the URL pattern list 119 to determine whether the hash prefix value should be generated based on the (unmodified) URL, or based on a simplified/conformed version of the URL (as guided by the URL pattern list 119). This decision is represented at step 214, where the web browser application 124 determines whether the URL can be matched to a particular URL pattern definition included in the URL pattern list 119. In one example, if the URL pattern list 119 does not reference the domain of the URL, then the web browser application 124 determines that the URL cannot be matched to a particular URL pattern definition. Alternatively, if the URL pattern list 119 does reference the domain of the URL, then the web browser application 124 can simplify, conform, etc., the URL in accordance with the structure provided in the URL pattern list 119—which, as described herein, can involve removing extraneous information from the URL.

If, at step 214, the web browser application 124 determines that the URL can be matched to a particular URL pattern definition within the URL pattern list 119, then the method 200 proceeds to step 216. As shown in FIG. 2B, at step 216, the web browser application 124 generates an updated URL based on the URL and the particular URL pattern definition. In the example illustrated in FIG. 3A, the updated URL is assigned the value “domain.com/articles?id=123”, which is extracted from the URL in accordance with the example URL pattern definition illustrated in FIG. 1B.

At step 218, the web browser application 124 generates a hash value based on the updated URL. Again, the hash value can be generated using the same hash function that is utilized by the server computing device 102, considering that matching operations are to take place between values managed by the web browser application 124 and values managed by the server computing device 102. In one example, the hash value output by the hash function is “f2a12bddcfe95d35103b37849e158bc68e93c06cc29e57b4b4e01b26f2aef742”. At step 220, the web browser application 124 truncates suffix information from the hash value to produce a hash prefix value. The truncated suffix information can constitute, for example, “cfe95d35103b37849e158bc68e93c06cc29e57b4b4e01b26f2aef742”, such that the hash prefix value is “f2a12bdd”. Again, it is noted that the truncation length, size, etc., can be modified so that a hash prefix value of appropriate length, size, etc., remains.

At step 222, the web browser application 124 provides the hash prefix value to the server computing device 102. According to some embodiments, and as described herein, the web browser application 124 can communicate with the server computing device 102 using a variety of approaches, e.g., by way of the Internet, by way of one or more private relays 114, and so on. As described herein, the server computing device 102 can reference the hash prefix value against the database 108 to identify webpage URL hash values 111, if any, having hash prefix values that match the hash prefix value. When at least one webpage URL hash value 111 (having a hash prefix value that matches the hash prefix value) is identified, the server computing device 102 is in possession of at least one webpage supplement 112 that corresponds to the webpage.

At step 224, the web browser application 124 receives, from the server computing device 102, at least one (or a plurality of hash values) (i.e., webpage URL hash values 111), where each webpage URL hash value 111 of the webpage URL hash values 111 has a respective hash prefix value that matches the hash prefix value. At step 226, the web browser application 124 identifies that the hash value matches one of the webpage URL hash values 111 included in the webpage URL hash values 111. In this regard, when the match is identified, the web browser application 124 effectively is made aware that at least one webpage supplement 112 is available (through the server computing device 102) for the webpage. In turn, the method 200 returns to step 208 of FIG. 2A, which—as described below in greater detail—involves the web browser application 124 indicating that at least one webpage supplement 112 is available for the webpage.

Returning now to step 214, if the web browser application 124 determines that the URL cannot be matched to a particular URL pattern definition within the URL pattern list 119, then the method 200 proceeds to step 216. As described herein, an inability to match the URL to a particular URL pattern definition within the URL pattern list 119 indicates, to the web browser application 124, that the server computing device 102 has not (at least yet) identified a specific approach for simplifying, conforming, etc., the URL. Accordingly, the method 200 proceeds to step 228 of FIG. 2C, which constitutes a start of an alternative approach relative to the approach illustrated in FIG. 2B.

As shown in FIG. 2C, at step 228, the web browser application 124 removes, from the URL, any query string information, fragment identifier information, etc., to produce a filtered URL. Consider, example, where for a scenario the user visits “https://example.com/item?id=123&user=abc&tracking=aaa”. In this example, the web browser application 124 can be configured to filter the following information out of the URL: “?id=123&user=abc&tracking=aaa”. As a result, the filtered URL becomes “https://example.com/item”. In this regard, potentially sensitive information, e.g., an item identifier (ID), a user ID, a tracking ID, a campaign ID, a mode ID, etc., is excluded in the filtered URL—which, as described herein, can further limit the server computing device 102 from gleaning information about the webpage the web browser application 124 is accessing. It is noted that the foregoing examples are not meant to be limiting, and that any amount, type, form, etc., of information can be removed from the URL, modified within the URL, etc., at any level of granularity, consistent with the scope of this disclosure.

At step 230, the web browser application 124 provides the filtered URL to a hash function to produce a hash value. Again, the web browser application 124 can utilize the same hash function that the server computing device 102 utilizes to generate the webpage URL hash values 111. In one example, the hash value output by the hash function is “44c380831c7ef26e7850ca19b68bec1efb94413ba41d39d18f6826d5d2888723c”. At step 232, the web browser application 124 truncates suffix information from the hash value to produce a hash prefix value. For example, “1c7ef26e7850ca19b68bec1efb94413ba41d39d18f6826d5d2888723c” can be truncated from the hash value such that the hash prefix value is “44c38083”. At step 234, the web browser application 124 provides the hash prefix value to the server computing device 102.

At step 236, the web browser application 124 receives, from the server computing device 102, a plurality of hash values (i.e., webpage URL hash values 111), where each hash value of the plurality of hash values: (i) has a respective hash prefix value that matches the hash prefix value, and (ii) is associated with a respective plurality of secondary hash values, where each secondary hash value of the respective plurality of secondary hash values is based on a respective URL variation of a particular URL to which the hash value corresponds. FIG. 1B illustrates example information (the example webpage URL hashes 154) that can be received by the web browser application 124 at step 236 in accordance with the example scenario described above in conjunction with steps 228-230. In particular, each “url_hash” entry included in the example webpage URL hashes 154 can correspond to the aforementioned hash values, and each “hash” entry included in the example webpage URL hashes 154 can correspond to the aforementioned secondary hash values. It should be appreciated that any text “//”, and any text associated therewith, in the example webpage URL hashes 154 is illustrated in FIG. 1B in the interest of aiding in the understanding of this disclosure, and that such text can be omitted from the example webpage URL hashes 154. It is noted that the example webpage URL hashes 154 illustrated in FIG. 1B are not meant to be limiting, and that the information returned to the web browser application 124 at step 236 can be organized in any manner, and can include any amount, type, form, etc., of information, at any level of granularity, consistent with the scope of this disclosure.

At step 238, the web browser application 124 generates a plurality of URL variations based on the URL. According to some embodiments, the URL variations can be generated based on subsets, re-orderings, etc., of the parameters that were filtered out of the URL at step 228 (i.e., “?id=123&user=abc&tracking=aaa”). The variations can include, for example, “https://example.com/item?id=123&user=abc&tracking=aaa”, “https://example.com/item?id=123&user=abc”, “https://example.com/item?id=123”, “https://example.com/item?user-abc&tracking=aaa”, “https://example.com/item?user=abc”, “https://example.com/item?tracking=aaa”, “https://example.com/item?id=123&tracking=aaa”, and so on.

At step 240, the web browser application 124 generates, for each URL variation of the plurality of URL variations, a respective hash value. Continuing with the examples described above in conjunction with steps 228-238, the hash values for the URL variations could respectively include “9905d6475b7bfb8531405b398598b8d2456d0ff1a2357e078ed51a0f5fdb8e7c4”, “dfc9217a8114455ada39ca3c8c49f3e7c7a7d645263efd6eeb6b66c1cb682550d”, “b87203f51bf52e7c46063de0d3b0690d1949f1a17f7f145dfcd86f227c74ada8b”, “578767662cf2de58fe8de90122557121dd26105ae239c8f6447f4f37653ca55a3”, “6c5a810b0d591bacc689462aeb9b600b558c67f5afec94956eb175571041011c7”, “cdcec3alc720cb41727598d98a7641cb5c7f63359029e520e83e439f4f77c6092”, “35ded98d09956624b213a8b793935ab166a427a43fccabc825f1ea54a7f0c69a3”, and so on.

At step 242, the web browser application 124 identifies, among the respective hash values for the plurality of URL variations, a particular respective hash value that matches a particular one of the secondary hash values. Continuing with the examples described above at steps 228-240—as well as the example webpage URL hashes 154 illustrated in FIG. 1B—the web browser application 124 can match the hash value “b87203f51bf52e7c46063de0d3b0690d1949f1a17f7f145dfcd86f227c74ada8b” to the hash variation “b87203f51bf52e7c46063de0d3b0690d1949f1a17f7f145dfcd86f227c74ada8b” included in the webpage URL hashes 154 (that corresponds to “https://example.com/item?id=321&mode=story”). In turn, the method 200 returns to step 208 of FIG. 2A, which—as described below in greater detail—involves the web browser application 124 indicating that at least one webpage supplement 112 is available for the webpage.

As a brief aside, it is noted that the server computing device 102 can provide accompanying information to the hash values that are returned to the web browser application 124 at step 224 of FIG. 2B and step 236 of FIG. 2C. For example, a given hash value can be associated with information that identifies a number of webpage supplements 112 that have been generated for the webpage (to which the hash value corresponds), identifiers for the types of webpage supplements 112 that have been generated for the webpage, and so on. In this manner, the web browser application 124 can indicate, for example, a number of webpage supplements 112 that are available for the webpage, the types of the webpage supplements 112 that are available for the webpage, and so on, so that a user of the web browser application 124 can conveniently determine whether they would like to take additional action (i.e., obtain/access one or more of the webpage supplements 112). It is noted that the foregoing examples are not meant to be limiting, and that the hash values can be accompanied by any amount, type, form, etc., of information, at any level of granularity, consistent with the scope of this disclosure.

Additionally, it is noted that the user preferences 128 can inform how the web browser application 124 should manage notifications about the availability of webpage supplements 112, requests to obtain webpage supplements 112, receipt/utilization of webpage supplements 112, and so on. For example, when only a particular type of webpage supplement 112 is available—and, based on the user preferences 128, that type of webpage supplement 112 is not of interest to the user, then the web browser application 124 can take no further action. In another example, when two or more types of webpage supplements 112 are available, the web browser application 124 can, based on the user preferences 128, prioritize notifying the user about the webpage supplement 112 among the two or more webpage supplements that is of the type that is of interest to the user. Additionally, a respective ranking score (established by the server computing device 102, the client computing device 120, etc.) can be assigned to each webpage supplement 112, where the respective ranking score indicates an overall relevance of the webpage supplement 112 to the web page, the user, etc. The ranking scores can be used individually—or can be combined with the user preferences 128—to effectively determine how to order the webpage supplements 112 that are displayed to the user. It is noted that the foregoing examples are not meant to be limiting, and that the user preferences 128 can be used to guide the manner in which webpage supplements 112 are suggested, presented, etc., to the user, consistent with the scope of this disclosure.

Turning back now to FIG. 2A, at step 208, the web browser application 124 displays at least one affordance (e.g., user interface) that corresponds to the respective at least one webpage supplement. Example affordances that can be output by the web browser application 124, client computing device 120, etc., are illustrated in FIG. 3B. For example, as shown in FIG. 3B, the web browser application 124 can display a star icon within a navigation bar of the user interface. The web browser application 124 can also display a banner indicating that the at least one webpage supplement 112—which, in the example illustrated in FIG. 3B, constitutes a summary of the webpage—is available to be obtained from the server computing device 102. It is noted that the examples illustrated in FIG. 3B are not meant to be limiting, and that the affordance(s) can be implemented using any number, type, form, etc., of approach(es), at any level of granularity, consistent with the scope of this disclosure.

At step 210, the web browser application 124 receives, by way of the at least one affordance, a second request to access the respective at least one webpage supplement. The second request can be received, for example, in conjunction with the selection 304 of the aforementioned icon illustrated in FIG. 3B.

At step 212, the web browser application 124 causes at least a portion of the respective at least one webpage supplement to be output by way of a user interface. To implement step 212, the web browser application 124 can issue, to the server computing device 102, a request for the at least one webpage supplement 112. The request can include a plain text representation of the URL, the hash value that corresponds to the URL, or any other information that enables the server computing device 102 to effectively identify and obtain the at least one webpage supplement 112 in response to the request. In this regard, the server computing device 102 may effectively be privy to the webpage that is being visited by the client computing device 120. Accordingly, the web browser application 124/client computing device 120 can be configured to communicate information between one another in an anonymized through utilization of the private relays 114 in accordance with the techniques described herein. In doing so, the server computing device 102 may be aware of the webpage that is being accessed, but may not be aware of the client computing device 120, user, etc., that is accessing the webpage, thereby substantially improving overall privacy.

When the web browser application 124 obtains the webpage supplement 112, the web browser application 124 can display the webpage supplement 112 in an appropriate manner. For example, as shown in FIG. 3C, the web browser application 124 can place the webpage supplement 112 over the webpage so that the webpage supplement 112 is in full view. The web browser application 124 can also include a banner that indicates the webpage summary is being viewed, and can include a user interface element that enables the webpage supplement 112 to be closed. As shown in FIG. 3C, a selection 306 to close the webpage supplement 112 is received, and, as shown in FIG. 3D, the web browser application 124 returns to displaying the webpage, while keeping the star icon displayed so that the webpage supplement 112 can be recalled.

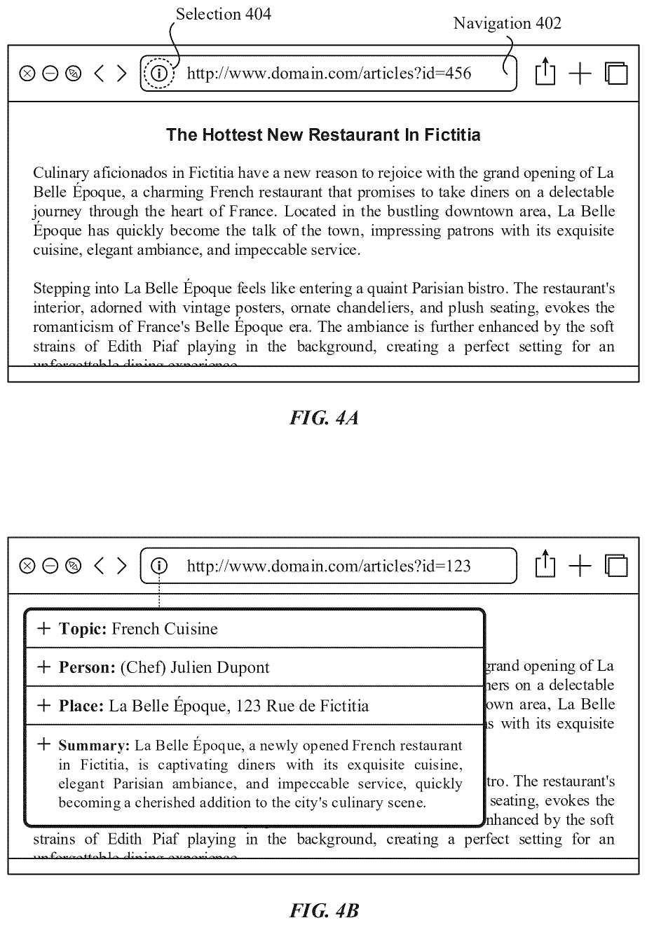

FIGS. 4A-4B illustrate conceptual diagrams of additional example user interfaces that can be provided by the web browser application 124 in conjunction with carrying out the techniques described herein, according to some embodiments. In particular, FIG. 4A illustrates an example user interface of the web browser application 124 as it accesses the webpage associated with the URL “http://www.domain.com/articles?id=456” (by way of a navigation 402 performed by a user, automatically, etc.), which includes a review of a new restaurant that has opened in Fictitia. As shown in FIG. 4A, the web browser application 124 determines, using the techniques described herein, that four webpage supplements 112 are available for the webpage. As shown in FIG. 4A, an icon (that is distinct from the star icon illustrated in FIG. 3B) can be used to indicate that two or more webpage supplements 112 are available (rather than the examples illustrated in FIGS. 3A-3D that involve a single webpage supplement 112 being available).

As shown in FIG. 4A, a selection 404 of the icon is made, which causes the web browser application 124 to display the webpage supplements 112 by way of the user interface illustrated in FIG. 4B. As shown in FIG. 4B, the user interface includes a first webpage supplement 112 that indicates a topic of the webpage, a second webpage supplement 112 that indicates a person of interest mentioned in the webpage, a third webpage supplement 112 that indicates a place of interest in the webpage, and a fourth webpage supplement 112 that constitutes a summary of the webpage. Moreover, the user interface includes “+” icons that, when selected, can cause the web browser application 124 to provide additional features, such as displaying additional information about a given webpage supplement 112, accessing additional features included in the webpage supplement 112, and so on. For example, when a webpage supplement 112 constitutes a table of contents of the webpage (not illustrate in FIG. 4B), different parts of the table of contents (e.g., Title, Sections, Subsections, Page Numbers, Appendices, Figures/Tables, References, etc.) can be associated with hyperlinks, buttons, etc., that, when selected, cause the web browser application 124 to navigate to the relevant portion of the webpage, highlight the relevant portion of the webpage, etc. Again, it is noted that the user interfaces illustrated in FIGS. 4A-4B are not meant to be limiting, and that the user interfaces can include any amount, type, form, etc., of information, at any level of granularity, consistent with the scope of this disclosure.

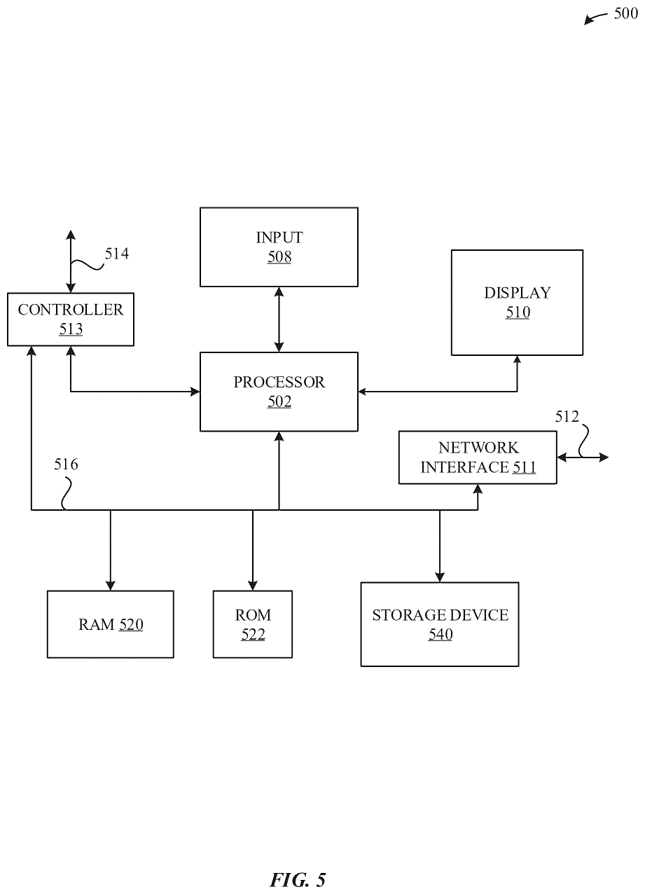

FIG. 5 illustrates a detailed view of a computing device 500 that can be used to implement the various techniques described herein, according to some embodiments. In particular, the detailed view illustrates various components that can be included the computing devices described above in conjunction with FIG. 1A. As shown in FIG. 5, the computing device 500 can include a processor 502 that represents a microprocessor or controller for controlling the overall operation of the computing device 500. The computing device 500 can also include a user input device 508 that allows a user of the computing device 500 to interact with the computing device 500. For example, the user input device 508 can take a variety of forms, such as a button, keypad, dial, touch screen, audio input interface, visual/image capture input interface, input in the form of sensor data, and so on. Still further, the computing device 500 can include a display 510 that can be controlled by the processor 502 (e.g., via a graphics component) to display information to the user. A data bus 516 can facilitate data transfer between at least a storage device 540, the processor 502, and a controller 513. The controller 513 can be used to interface with and control different equipment through an equipment control bus 514. The computing device 500 can also include a network/bus interface 511 that couples to a data link 512. In the case of a wireless connection, the network/bus interface 511 can include a wireless transceiver.

As noted above, the computing device 500 also includes the storage device 540, which can comprise a single disk or a collection of disks (e.g., hard drives). In some embodiments, storage device 540 can include flash memory, semiconductor (solid-state) memory or the like. The computing device 500 can also include a Random-Access Memory (RAM) 520 and a Read-Only Memory (ROM) 522. The ROM 522 can store programs, utilities, or processes to be executed in a non-volatile manner. The RAM 520 can provide volatile data storage, and stores instructions related to the operation of applications executing on the computing device 500.

The various aspects, embodiments, implementations, or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data that can be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

The terms “a,” “an,” “the,” and “said” as used herein in connection with any type of processing component configured to perform various functions may refer to one processing component configured to perform each and every function, or a plurality of processing components collectively configured to perform each of the various functions. By way of example, “A processor” configured to perform actions A, B, and C may refer to one or more processors configured to perform actions A, B, and C. In addition, “A processor” configured to perform actions A, B, and C may also refer to a first processor configured to perform actions A and B, and a second processor configured to perform action C. Further, “A processor” configured to perform actions A, B, and C may also refer to a first processor configured to perform action A, a second processor configured to perform action B, and a third processor configured to perform action C.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

As described herein, one aspect of the present technology is the gathering and use of data available from various sources to improve user experiences. The present disclosure contemplates that in some instances, this gathered data may include personal information data that uniquely identifies or can be used to contact or locate a specific person. Such personal information data can include demographics data, location-based data, telephone numbers, email addresses, home addresses, data or records relating to a user's health or level of fitness (e.g., vital signs measurements, medication information, exercise information), date of birth, smart home activity, or any other identifying or personal information. The present disclosure recognizes that the use of such personal information data, in the present technology, can be used to the benefit of users.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select to provide only certain types of data that contribute to the techniques described herein. In addition to providing “opt in” and “opt out” options, the present disclosure contemplates providing notifications relating to the access or use of personal information. For instance, a user may be notified that their personal information data may be accessed and then reminded again just before personal information data is accessed.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

What is claimed is:

1. A method, comprising:
by a client computing device:
receiving a first request to load a webpage associated with a uniform resource locator (URL);
identifying, by comparing a domain of the URL against a probabilistic data structure, that there potentially exists a respective at least one webpage supplement for the webpage, wherein:
the probabilistic data structure is based on a plurality of domains; and
respective one or more webpage supplements exist for each domain of the plurality of domains;
identifying, by interfacing with a management entity, that the respective at least one webpage supplement in fact exists;
displaying at least one affordance that corresponds to the respective at least one webpage supplement;
receiving, by way of the at least one affordance, a second request to access the respective at least one webpage supplement; and
causing at least a portion of the respective at least one webpage supplement to be output by way of a user interface.

2. The method of claim 1, further comprising:
prior to comparing the domain of the URL against the probabilistic data structure:
referencing the domain against a group of blocked domains; and
determining that the domain is not included in the group of blocked domains.

3. The method of claim 1, wherein identifying that the respective at least one webpage supplement in fact exists comprises:
identifying that the URL can be matched to a particular URL pattern definition among a plurality of URL pattern definitions;
generating an updated URL based on the URL and the particular URL pattern definition;
generating a hash value based on the updated URL;
truncating suffix information from the hash value to produce a hash prefix value;
providing the hash prefix value to the management entity;
receiving, from the management entity, a plurality of hash values, wherein each hash value of the plurality of hash values has a respective hash prefix value that matches the hash prefix value; and
identifying that the hash value matches one of the hash values included in the plurality of hash values.

4. The method of claim 1, wherein identifying that the respective at least one webpage supplement in fact exists comprises:
identifying that the URL cannot be matched to a particular URL pattern definition among a plurality of URL pattern definitions;
removing, from the URL, any query string and fragment identifier information, to produce a filtered URL;
providing the filtered URL to a hash function to produce a hash value; and
truncating suffix information from the hash value to produce a hash prefix value.

5. The method of claim 4, further comprising:
providing the hash prefix value to the management entity;
receiving, from the management entity, a plurality of hash values, wherein each hash value of the plurality of hash values:
has a respective hash prefix value that matches the hash prefix value; and
is associated with a respective plurality of secondary hash values, wherein each secondary hash value of the respective plurality of secondary hash values is based on a respective URL variation of a particular URL to which the hash value corresponds;
generating a plurality of URL variations based on the URL;
generating, for each URL variation of the plurality of URL variations, a respective hash value; and
identifying, among the respective hash values for the plurality of URL variations, a particular respective hash value that matches a particular one of the secondary hash values.

6. The method of claim 1, further comprising, prior to causing the at least a portion of the respective at least one webpage supplement to be output by way of the user interface:
eliminating any path, query string, and fragment identifier information from the URL to produce a filtered URL;
issuing, to the management entity, a third request to obtain the respective at least one webpage supplement, wherein the third request includes the filtered URL and excludes identifying information associated with the client computing device; and
receiving, from the management entity, the respective at least one webpage supplement.

7. The method of claim 6, wherein the third request is issued to the management entity, and the respective at least one webpage supplement is received from the management entity, by way of at least one independent relay server that prevents the management entity from identifying address information associated with the client computing device.

8. The method of claim 1, wherein the respective at least one webpage supplement comprises:
a summary of content included in the webpage;
a table of contents of different sections included in the webpage;
identifications of a person, a place, a topic, or media content included in the webpage; or
some combination thereof.

9. The method of claim 1, wherein, when the respective at least one webpage supplement includes two or more webpage supplements, the method further comprises:
establishing, for each webpage supplement of the two or more webpage supplements, a respective client ranking score based on preferences associated with a user account registered on the client computing device, a respective server ranking score associated with the webpage supplement, or some combination thereof; and
identifying, based on the client ranking scores, a most relevant webpage supplement of the two or more webpage supplements, wherein causing the at least a portion of the respective at least one webpage supplement to be output by way of the user interface involves displaying at least a portion of the most relevant webpage supplement.

10. A non-transitory computer-readable storage medium storing one or more programs configured to be executed by one or more processors of a computing device, the one or more programs include instructions for:
receiving a first request to load a webpage associated with a uniform resource locator (URL);
identifying, by comparing a domain of the URL against a probabilistic data structure, that there potentially exists a respective at least one webpage supplement for the webpage, wherein:
the probabilistic data structure is based on a plurality of domains; and
respective one or more webpage supplements exist for each domain of the plurality of domains;
identifying, by interfacing with a management entity, that the respective at least one webpage supplement in fact exists;
displaying at least one affordance that corresponds to the respective at least one webpage supplement;
receiving, by way of the at least one affordance, a second request to access the respective at least one webpage supplement; and
causing at least a portion of the respective at least one webpage supplement to be output by way of a user interface.

11. A computing device, comprising:
one or more processors; and
memory storing one or more programs configured to be executed by the one or more processors, the one or more programs including instructions for:
receiving a first request to load a webpage associated with a uniform resource locator (URL);
identifying, by comparing a domain of the URL against a probabilistic data structure, that there potentially exists a respective at least one webpage supplement for the webpage, wherein:
the probabilistic data structure is based on a plurality of domains, and
respective one or more webpage supplements exist for each domain of the plurality of domains;
identifying, by interfacing with a management entity, that the respective at least one webpage supplement in fact exists;
displaying at least one affordance that corresponds to the respective at least one webpage supplement;
receiving, by way of the at least one affordance, a second request to access the respective at least one webpage supplement; and
causing at least a portion of the respective at least one webpage supplement to be output by way of a user interface.
